(19) United States
(12) Patent Application Publication
(10) Pub. No.: US 2022/0038586 A1
(43) Pub. Date: Feb. 3, 2022

(54) IMAGE PROCESSING APPARATUS, CONTROL METHOD, AND MEDIUM

(71) Applicant: CANON KABUSHIKI KAISHA, Tokyo (JP)

(72) Inventor: Ritsuto Sako, Tokyo (JP)

(21) Appl. No.: 17/377,810

(22) Filed: Jul. 16, 2021

(30) Foreign Application Priority Data
Jul. 29, 2020 (JP) 2020-128508

(51) Int. Cl. H04N 1/00; G06F 3/12; H04L 29/08

(52) U.S. Cl. CPC H04N 1/00244; H04N 1/00278; G06F 3/1236; H04L 67/2814; G06F 3/1203; G06F 3/1287

(57) ABSTRACT

An image processing apparatus that communicates with an external apparatus on an external network via a proxy server is provided. The apparatus performs, in a case where a setting for a predetermined function that communicates with the external network for allowing communication to bypass the proxy server is set to on, registering two or more connection destinations used by the predetermined function as exception addresses that allow communication to bypass the proxy server, and, in a case where communication is performed with an external connection destination, executing control such that communication is performed with the connection destination via the proxy server or bypassing the proxy server on the basis of whether or not the connection destination is registered in the exception addresses.

### BACKGROUND OF THE INVENTION

### Field of the Invention

The present invention relates to an image processing apparatus that communicates via a proxy server.

### Description of the Related Art

In a known printing service, printing is implemented by the user transmitting a print job directly from a client terminal such as a PC to a printing apparatus. However, in recent years, cloud printing services have been developed that use a cloud service provided on the Internet.

To use cloud printing, the user first needs to register a printing apparatus with a cloud printing registration service. Also, when using cloud printing, the user logs into the cloud printing service from a client terminal and transmits a cloud device ID of the registered printing apparatus and print data to the cloud printing service. To print, the printing apparatus transmits a print job request including the cloud device ID to the cloud printing service. The cloud printing service identifies the managed printing apparatus from the cloud device ID and transmits a print job including the print data transmitted for the printing apparatus to the printing apparatus. The printing apparatus performs the received print job.

However, companies typically employ a configuration in which communication from an in-company intranet to the Internet is performed via a proxy server. In a cloud printing service, typically, the printing apparatus is placed on the intranet, and the cloud printing service is a service on the Internet.

Also, an information processing apparatus is known that communicates via a proxy server (Japanese Patent Laid-Open No. 2018-146997). In Japanese Patent Laid-Open No. 2018-146997, a technique is described for setting an IP address, a port number, a proxy exception list, and the like of the proxy server as settings for proxy access.

However, this places a large communication load on the cloud printing service for transmitting and receiving print data to and from the cloud server. Accordingly, with a configuration in which communications between an image processing apparatus such as a printing apparatus and the cloud printing service pass through a proxy server, the load on the communication proxy server is increased, making printing take longer or even failing. To circumvent this, a technique may be used in which access to the cloud printing service bypasses a proxy server. To achieve this, conceivably, device operation is performed by a user such as an administrator who uses a software keyboard or the like to input and add an endpoint (a connection destination such as a URL, for example) for accessing the cloud printing service into proxy exception settings, i.e., the communication settings of a printing apparatus.

However, an endpoint such as a URL of the cloud printing service is first received from the cloud printing service when an image processing apparatus such as a printing apparatus is registered with the cloud printing service. In other words, the URL to be added to the proxy exception settings is not set in advance, meaning the user does not know in advance which URL to manually add to the proxy exception settings. Thus, for a user without technical knowledge relating to network settings, it is difficult to set the cloud printing to bypass the proxy server. Furthermore, the URL received from the cloud printing registration service is a connection destination used internally in the image processing apparatus. This makes is difficult for the end user to confirm the URL indicating the connection destination.

The present invention is directed at providing a system that is easily set such that communication via a proxy server is maintained in principle and, as an exception, the proxy server may be bypassed for a connection destination corresponding to a predetermined function.

### SUMMARY OF THE INVENTION

According to one aspect of the present invention, an image processing apparatus that communicates with an external apparatus on an external network via a proxy server, comprising: at least one memory that stores a set of instructions; and at least one processor that executes the instructions, the instructions, when executed, causing the image processing apparatus to perform operations comprising: in a case where a setting for a predetermined function that communicates with the external network for allowing communication to bypass the proxy server is set to on, registering two or more connection destinations used by the predetermined function as exception addresses that allow communication to bypass the proxy server, and, in a case where communication is performed with an external connection destination, executing control such that communication is performed with the connection destination via the proxy server or bypassing the proxy server on the basis of whether or not the connection destination is registered in the exception addresses is provide.

According to the present invention, a system can be easily set such that communication via a proxy server can be maintained in principle and, as an exception, the proxy server may be bypassed for a connection destination corresponding to a predetermined function.

Further features of the present invention will become apparent from the following description of exemplary embodiments with reference to the attached drawings.

### BRIEF DESCRIPTION OF THE DRAWINGS

FIG. 1 is a diagram illustrating the configuration of a cloud printing system according to an embodiment.

FIG. 2 is a diagram illustrating the hardware configuration of a printing apparatus according to an embodiment.

FIG. 3 is a diagram illustrating the software configuration of a printing apparatus according to an embodiment.

FIG. 4 is an explanatory diagram of an operation panel of a printing apparatus according to an embodiment.

FIG. 5 is a diagram illustrating a processing sequence of cloud printing.

FIG. 6 is a flowchart of operations of a printing apparatus for cloud printing registration.

FIG. 7 is a diagram illustrating a UI for setting cloud printing setting of a printing apparatus according to the first embodiment.

FIG. 8 is a flowchart of cloud printing registration service operations for cloud printing registration.

FIG. 9 is a flowchart of when a exception setting of cloud printer settings are changed for the printing apparatus according to the first embodiment.

FIGS. 10A and 10B is a flowchart illustrating the processing executed when cloud printing service printer registration is performed with the printing apparatus according to the first embodiment.

FIG. 11 is a flowchart illustrating the processing executed when printing with the cloud printing service is performed via the printing apparatus according to the first embodiment.

FIG. 12 is a diagram illustrating a UI where proxy setting of a printing apparatus is performed on the printing apparatus according to a second embodiment.

FIG. 13 is a flowchart of when a exception setting of proxy settings of the printing apparatus are changed for the printing apparatus according to the second embodiment.

FIG. 14 is a diagram illustrating a list of endpoint information used by the printing apparatus according to the first embodiment and the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

System Configuration

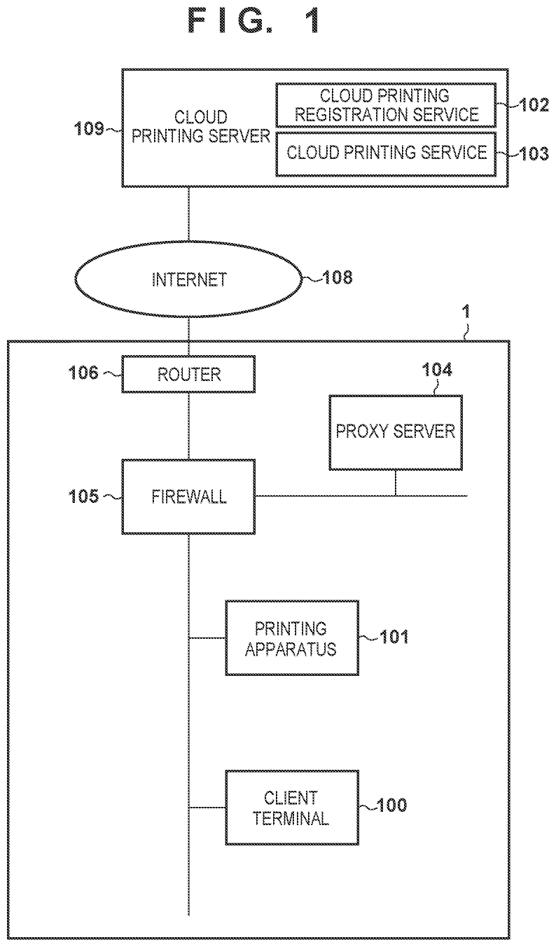

FIG. 1 is a block diagram illustrating the configuration of a cloud printing system. A local network (also referred to as a client network) 1 is connected to an Internet 108 via a router 106, and a cloud printing server 109 is connected to the Internet 108. An apparatus on a network external to the local network 1 is referred to as an external apparatus. The cloud printing server 109 is provided with a cloud printing registration service 102 and a cloud printing service 103 and provides these services. Note that the cloud printing registration service 102 and the cloud printing service 103 may be provided by different servers.

The local network 1 is configured as a local area network. A printing apparatus 101 and a client terminal 100 are connected to the router 106 via a firewall 105. Also, a proxy server 104 is connected to the firewall 105. The local network 1, in principle, is set such that communications with an external unit (i.e., the internet 108) are performed via the proxy server 104. In the present embodiment, the printing apparatus 101 is used as an example of an image processing apparatus. Note that the printing apparatus 101 may be a multi-function peripheral including a copying function, a scanning function, and the like or may be a printing apparatus with the simple function of providing only a printing function. The printing apparatus may also be referred to as a printer or an image forming apparatus. Alternatively, focusing on an information processing function, it may also be referred to as an information processing apparatus. Also, the function described as a function of the printing apparatus 101 in the present embodiment and the second embodiment may be provided by an information processing apparatus such as a general-purpose computer and configured to print print data obtained by the information processing apparatus via cooperation between the information processing apparatus and a printing apparatus under its control. In other words, the present embodiment may be applied to a printing control apparatus, such as a printing server, that relays print data between the cloud printing server and a printing apparatus including an actual printing resource.

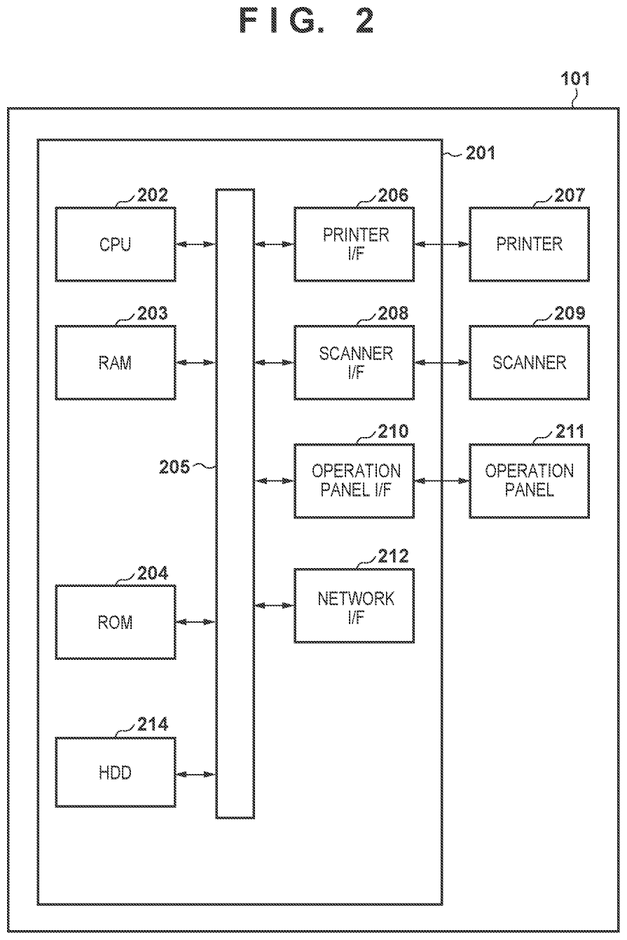

FIG. 2 is a block diagram illustrating the hardware configuration of the printing apparatus 101. A control unit 201 including a central processing unit (CPU) 202 controls the overall operations of the printing apparatus 101. The CPU 202 deploys a control program stored in a read-only memory (ROM) 204 or a hard disk drive (HDD) 214 on a random-access memory (RAM) 203, reads out and executes the deployed program, and performs communication control and other types of control. The CPU 202 may also be referred to as a processor, a processing apparatus, or a processing unit. The ROM 204 may be a programmable ROM capable of writing additional data.

The RAM 203 is used as a temporary storage region, for example, the main memory of the CPU 202, a working area, and the like. The HDD 214 is a non-volatile storage region that stores data, various programs, and various information tables. In this manner, the hardware including the CPU 202, the ROM 204, the RAM 203, storage 114, and the like constitute a so-called computer.

Note that in the printing apparatus 101 of the present embodiment, one CPU 202 uses one memory (the RAM 203) to execute the processing illustrated in the flowchart described below. However, other configurations may be used. For example, a plurality of processors, memories, and storages may be configured to cooperate to execute the processing illustrated in the flowchart described below. Also, a portion of the processing (for example, conversion processing of the print image) may be configured to be executed using a hardware circuit.

A printer interface (I/F) 206 is an interface that outputs an image signal to a printer 207 (printer engine). The printer 207 forms an image on a sheet, such as a paper sheet, conveyed from a feed cassette, not illustrated, on the basis of an image signal and a print control signal received from the control unit 201. The sheet on which an image is formed is then discharge to a discharge tray, not illustrated. The printing method may be an electrophotographical method in which toner is transferred and fixed to paper or an inkjet method in which printing is performed by discharging ink on paper.

Also, a scanner I/F 208 is an interface that inputs a read image signal from a scanner 209 (scanner engine). The scanner 209 is a scanner device that reads a document placed on a platen, not illustrated, and generates an image signal. In a case where there is an instruction to execute copying processing via the printing apparatus 101, the CPU 202 processes the image signal input via the scanner I/F 208 and generates a record image signal and a print control signal. Then, the generated record image signal and print control signal are output to the printer via the printer I/F 206. The printer executes the printing processing described above on the basis of the record image signal and the print control signal. Also, for example, in a case where there is a transmission instruction for the printing apparatus 101 to transmit scan data to an external apparatus, the CPU 202 transmits the file generated on the basis of the image signal to the external apparatus. In this case, the file to be transmitted is expected to be an image file, but no such limitation is intended. For example, the file may be a file with a format corresponding to PDF or a document file (for example, a file with a Word (registered trademark) format) generated on the basis of an image.

An operation panel I/F 210 connects an operation panel 211 and the control unit 201. The operation panel 211 is provided with a liquid crystal display unit with a touch panel function, a keyboard, or the like.

A network I/F 212 transmits information to an external terminal, such as the client terminal 100, a cloud printing service 103, or the like, receives various information from the external apparatuses, and the like. In the present example, the network I/F 212 may be a local area network (LAN) I/F. The blocks in the control unit 201 are connected via a system bus 205.

The client terminal 100 may be a general-purpose computer, a tablet terminal, a smart phone, or the like. For example, in the case of a tablet terminal or a smart phone, the configuration may lack the printer I/F 206, the printer 207, the scanner I/F 208, and the scanner 209 of FIG. 2. Also, in the case of a personal computer, the configuration may include an operation unit such as a keyboard and a display instead of an operation panel.

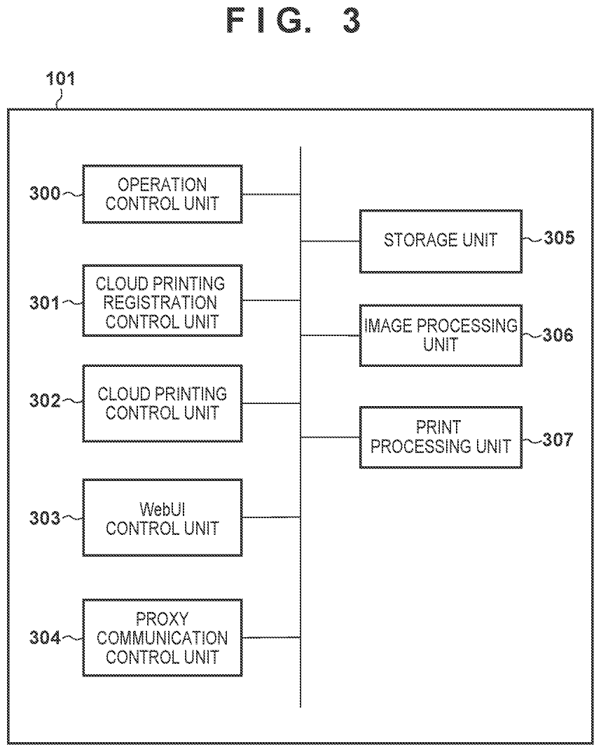

FIG. 3 is a diagram for describing the software configuration of the printing apparatus 101. The functional units illustrated in FIG. 3 are implemented by the CPU 202 including the printing apparatus 101 executing a control program.

An operation control unit 300 controls the operation panel 211. The operation control unit 300 displays an operation menu and receives the input of instructions from a user, notifies other functional units of the contents of the received instruction, and displays the instruction result on the operation panel 211.

A cloud printing registration control unit 301 controls cloud printing registration processing. A cloud printing control unit 302 controls processing to issue a print instruction to an image processing unit 306 and transfer print data 134 received from the cloud printing service 103.

A Web UI control unit 303 controls the Web UI with which a user uses HTTP to perform device setting operations from a PC or the like. A proxy communication control unit 304 controls proxy communication.

A storage unit 305 stores data designated by an instruction from another functional unit in the ROM 204 or the HDD 214. The storage unit 305 may also read out stored data. An example of data managed by the storage unit 305 includes registered cloud printer information.

The image processing unit 306 executes processing to render the print job into image data for printing. A print processing unit 307 executes processing to transmit, via a printer I/F 206, the image data rendered by the image processing unit 306 to a printer 207 as an image signal and print.

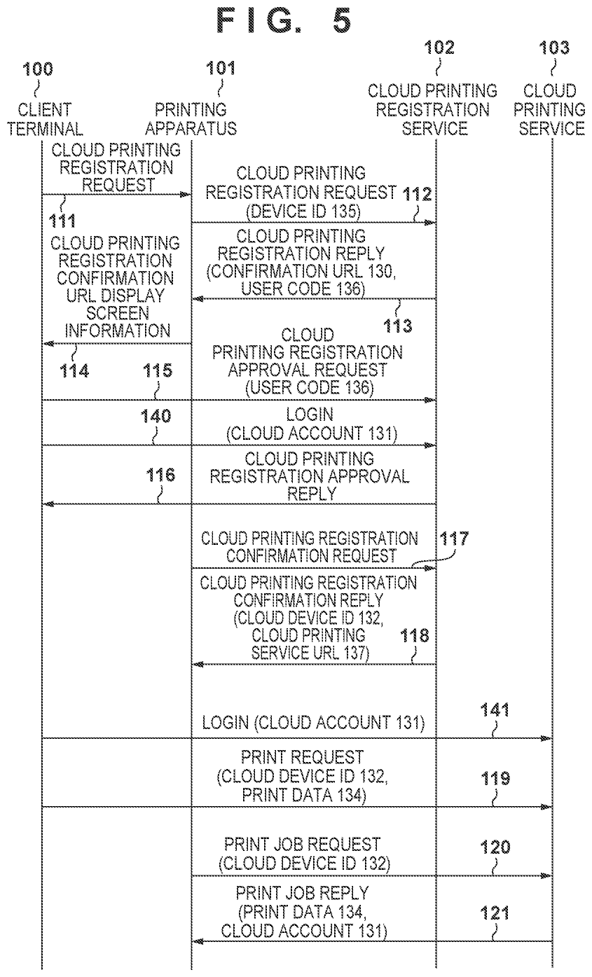

The software of the client terminal 100 includes an operating system, a device driver, and an application. The application includes a program for causing a computer to function as the client terminal 100 illustrated in FIG. 5 described below.

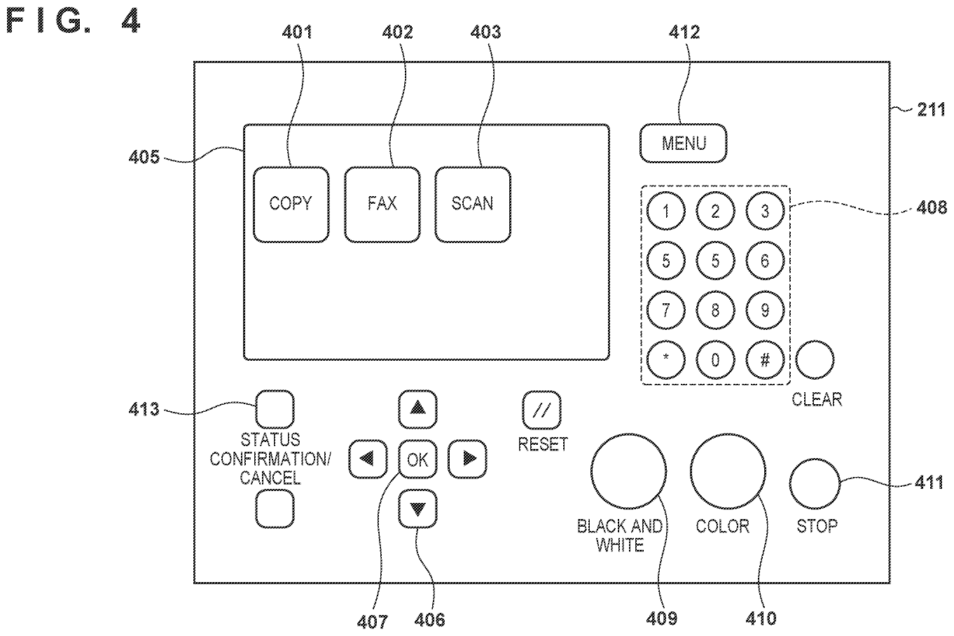

FIG. 4 is a diagram for describing the operation panel 211 of the printing apparatus 101. A display panel 405 is a touch panel utilizing an LCD or the like. A button 401 is a button that is pressed to perform copying using the printing apparatus 101, and by pressing the button 401, a copy operation screen is displayed on the display panel 405. A button 402 is a button that is pressed to send a FAX using the printing apparatus 101, and by pressing the button 402, a FAX operation screen is displayed on the display panel 405. A button 403 is a button that is pressed to perform scanning using the printing apparatus 101, and by pressing the button 403, a scan operation screen is displayed on the display panel 405. A tenkey 408 is used to input numbers and the like. An OK key 407 is used when confirming display contents of the display panel 405. A directional key 406 is used when selecting a menu or the like displayed on the display panel 405. Buttons 409, 410 are used to perform black and white copying and color copying. A stop button 411 is used to stop processing. A menu button 412 is used to display a menu screen for setting the settings of the printing apparatus 101. A status confirmation button 413 is used to display a list of print jobs received by the printing apparatus 101 and to confirm the status of the printing apparatus 101.

The cloud printing system with the configuration described above will be further described using two embodiments that differ in terms of the operation of the printing apparatus 101 upon cloud printing registration.

### First Embodiment

The first embodiment relates to a method of setting communications in which a communication destination used by a cloud printing service can be automatically added as a proxy exception by a proxy exception setting being provided in the cloud printing settings of the printing apparatus 101 and this setting being enabled. FIG. 5 is a diagram illustrating a processing sequence of the cloud printing system from registration of a printing apparatus to printing.

Cloud Printing Processing Sequence

FIG. 5 is a diagram for describing a processing sequence of cloud printing. The printing apparatus 101 is configured to support a cloud printing function and a Web UI function for operating the printing apparatus 101. The client terminal 100 is configured to support a cloud printing client function and a Web UI client for operating the Web UI. Note that in FIG. 5 not all of the messages are displayed, and some messages are omitted to decrease the complexity of the description. Also, in a case where a Web UI function cannot be used, the operation panel 211 of the printing apparatus 101 may be used where the Web UI client is used. Furthermore, though not illustrated in FIG. 5, the proxy server 104 may be provided between the client terminal 100 and the printing apparatus 101 and the cloud printing registration service 102 and the cloud printing service 103.

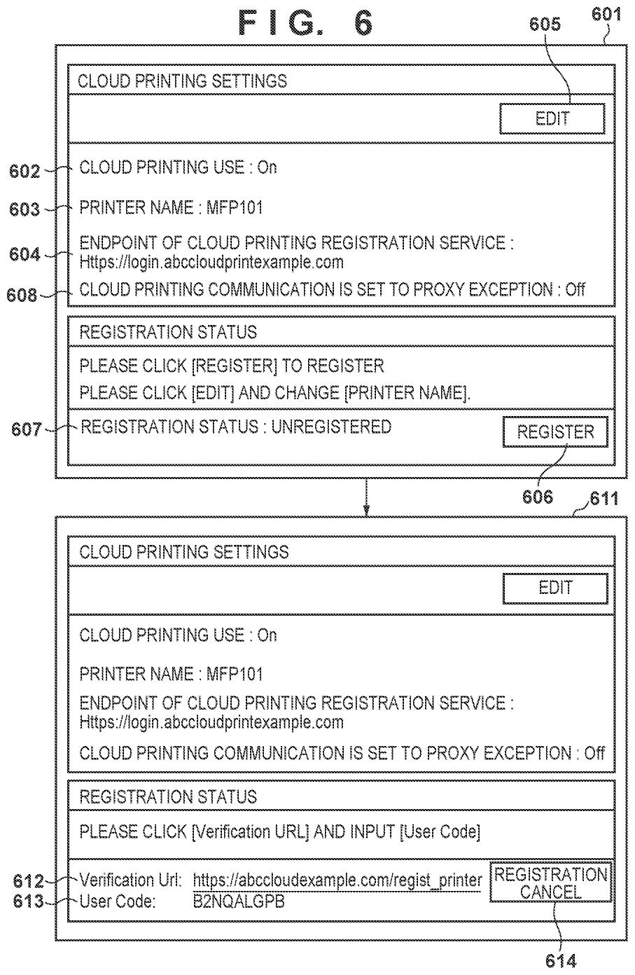

The user first uses the Web UI client of the client terminal 100 and transmits a cloud printing registration request 111 to the printing apparatus 101 via the Web UI. A screen 601 of FIG. 6 is an example of a screen displayed on the client terminal 100 when transmitting a registration request. When a registration button 606 on the screen 601 is touched, the cloud printing registration request 111 is transmitted. Hereinafter, in the present embodiment, a button or a label for presenting information displayed on a screen may be referred to as an object or a display object. When the printing apparatus 101 receives the cloud printing registration request 111, the printing apparatus 101 transmits a cloud printing registration request 112 to the cloud printing registration service 102. A device ID 135 for the cloud printing registration service 102 to identify the printing apparatus 101 is included in the cloud printing registration request 112. The device ID 135 is generated by the printing apparatus 101. When the cloud printing registration service 102 receives the cloud printing registration request 112, the cloud printing registration service 102 transmits a cloud printing registration reply 113 including a confirmation URL 130 and a user code 136 for cloud printing registration to the printing apparatus 101. When the printing apparatus 101 receives the cloud printing registration reply 113, the printing apparatus 101 transmits registration confirmation URL display screen information 114 including a cloud printing service URL to the client terminal 100 via the Web UI function.

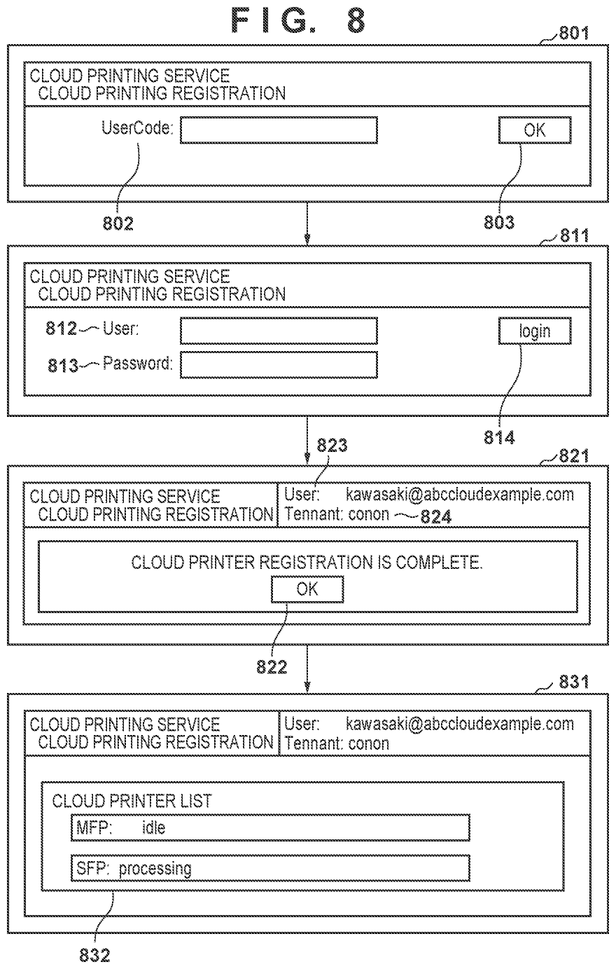

When the client terminal 100 receives the registration confirmation URL display screen information 114, the client terminal 100 displays a confirmation URL display screen including the confirmation URL 130 and the user code 136 on the Web UI client. A screen 611 of FIG. 6 is an example of such. A registration confirmation URL 612 (130) and a user code 613 are displayed on this screen. The registration confirmation URL 612 is displayed with a link attached. The user operates the Web UI client of the client terminal 100 and touches the registration confirmation URL 612 to access the registration confirmation URL 130 of the cloud printing registration service 102. In response to this, the client terminal 100 receives and displays a user code input screen. A screen 801 of FIG. 8 is an example of such. When the user inputs a user code and touches an OK button 803, the client terminal 100 transmits a cloud printing registration approval request 115 including a cloud account 131 and the user code 136 to the cloud printing registration service 102.

If the user is not logged in, the cloud printing registration service 102 transmits screen information for login to the client terminal 100. The user enters the user ID and password for the cloud account 131 of the user on the screen displayed on the client terminal 100 on the basis of the received screen information and login 140 is performed. A screen 811 of FIG. 8 is an example of such. If such an account exists, the user is authenticated by the cloud printing registration service 102 and the registration approval request is accepted.

When the cloud printing registration service 102 receives the cloud printing registration approval request 115 from an authenticated user or the transmission source user is authenticated, the cloud printing registration service 102 transmits a cloud printing registration approval reply 116 to the client terminal 100. A screen 821 of FIG. 8 illustrates an example of a screen displayed by the client terminal 100 that has received the cloud printing registration approval reply 116. Also, a screen 831 of FIG. 8 illustrates a screen of when an OK button 822 is touched at this time.

The printing apparatus 101 transmits a cloud printing registration confirmation request 117 to the cloud printing registration service 102. This transmission may be performed in response to an operation of the printing apparatus 101 by the user who performed cloud printing registration via the client terminal 100, for example. Alternatively, this transmission may be performed in response to a message from the client terminal 100. Alternatively, this transmission may be periodically performed until a cloud printing confirmation reply 118 is received after reception of the cloud printing registration reply 113. When the cloud printing registration service 102 receives the cloud printing registration confirmation request 117, in a case where the transmission source printing apparatus 101 is already registered, the cloud printing registration service 102 transmits a cloud printing registration confirmation reply 118. The cloud printing registration confirmation reply 118 includes a cloud device ID 132 of the printing apparatus 101 and a cloud printing service URL 137. In this example, the cloud printing service URL 137 does not need to be a URL prepared in advance and may be a URL generated by the cloud printing registration service 102 in response to a registration request.

At this point, the printing apparatus 101 is now registered with the cloud printing service 103 and cloud printing is able to be used.

A user who wishes to perform cloud printing uses the client terminal 100 to perform the login 140 into the cloud printing service 103 with the cloud account 131. Also, a print request 119 including the cloud device ID 132 and the print data 134 is transmitted to the cloud printing service 103. In this manner, print data for cloud printing by the printing apparatus 101 is stored by the cloud printing service 103.

The printing apparatus 101 transmits a print job request 120 including the cloud device ID 132 to the cloud printing service 103. This transmission may be performed in response to an operation of the printing apparatus 101 by a user who registered print data for printing via the printing apparatus 101 in the cloud printing service 103 or a user informed of a registration. The cloud printing service 103 that has received the print job request 120 identifies the printing apparatus 101 managed on the cloud from the cloud device ID 132 transmitted via the print job request 120. Also, a print job reply 121 including the print data 134 transmitted to the printing apparatus 101 and the cloud account 131 that transmitted the print data 134 is transmitted to the printing apparatus 101

The printing apparatus 101 prints the received print data 134 as the print job of the cloud account 131.

With the process described above, a printing apparatus can be registered with a cloud printing service, and a cloud printing function can be provided. Here, as described above, the proxy server 104 may be provided between the client terminal 100 and the printing apparatus 101 and the cloud printing registration service 102 and the cloud printing service 103. In the present embodiment, proxy settings can be easily changed when registering the printing apparatus with the cloud printing service or after registration. A setting method or a method of changing settings will be described below.

Examples of Cloud Printing Registration Operation Screen

FIG. 6 is a diagram illustrating operation screens of the printing apparatus 101 for executing cloud printing registration processing. The display timing has been mentioned with reference to FIG. 1, however the contents will be described in further detail below. The operation screens of FIG. 6 may be a UI displayed on a display panel 211 or may be a Web UI where operations are performed by accessing, from a PC or the like, a Web server that runs inside the printing apparatus 101. Note that the UI described below is assumed to be a Web UI.

The screen 601 is a screen for setting settings of the cloud printing and registration. The screen is provided by the web server function of the printing apparatus 101 by accessing a uniform resource locator (URL) of the Web UI provided by the printing apparatus 101 from a web browser of the client terminal 100. A cloud printing use 602 indicates a cloud printing function on/off setting. A printer name 603 indicates the printer name registered in the cloud printing service. An endpoint 604 indicates an endpoint of the cloud printing registration service 102. When an edit button 605 is pressed, the screen transitions to a screen for changing the settings of the cloud printing use 602, the printer name 603, and the endpoint 604 of the cloud printing registration service. A registration status 607 indicates the registration status of the cloud printing. In a case of an unregistered status, “unregistered” is displayed, and in a case of a registered status, “registered” is displayed. A proxy setting 608 indicates whether or not the cloud printing communication is set to proxy exception where a proxy is bypassed. An exception setting corresponds to on, and a default setting corresponds to off.

When the registration button 606 on the screen 601 is pressed, the printing apparatus transmits the cloud printing registration request 112 to the cloud printing registration service 102 and receives the cloud printing registration reply 113 as a reply. When the cloud printing registration reply 113 is received, the operation screen transitions to the screen 611.

The screen 611 is a screen that displays the confirmation URL 130 and the user code 136 for performing cloud printing registration. The verification URL 612 indicates the confirmation URL 130. The user code 613 indicates the user code 136.

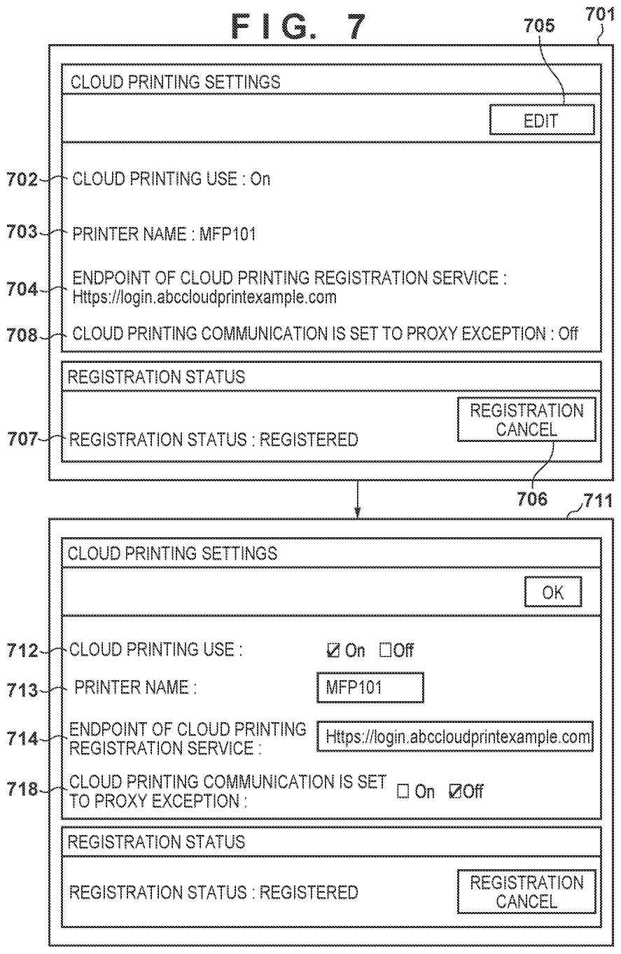

By a user entering the user code 136 after accessing the displayed confirmation URL 130 and logging into the cloud account 131, registration is completed. Thereafter, the operation screen transitions to a screen 701 of FIG. 7. Also, when a registration cancel button 614 is pressed, the printing apparatus 101 cancels the registration processing.

The screen 701 of FIG. 7 is a screen for setting cloud printing settings and/or registration, when the printing apparatus 101 according to the first embodiment is registered with the cloud printing service. The screen 601 and the screen 701 are different in that the screen 601 is a screen displayed when no printing apparatuses are registered, while the screen 701 of FIG. 7 is a screen displayed when there is a registered printing apparatus. A cloud printing use 702 indicates a cloud printing function on/off setting. A printer name 703 indicates the name or model number of the printing apparatus to be registered for cloud printing. An endpoint 704 indicates an endpoint of the cloud printing registration service 102. A proxy setting 708 indicates whether or not the cloud printing service communication destination is set to proxy exception. An exception corresponds to on, and not an exception corresponds to off. A registration status 807 indicates the registration status of the printing apparatus, and in screen 701, the registration status is shown as registered.

When an edit button 705 on the screen 701 is pressed (or touched), the screen transitions to a cloud printing settings screen 711. When a registration cancel button 706 is pressed, cloud printing registration cancellation is started. The screen 711 is a screen for changing the settings of cloud printing of the printing apparatus 101 in the first embodiment.

In a cloud printing setting 712, the on/off status of cloud printing can be changed by checking the on or off box. By switching the cloud printing setting 712 between on and off, the on/off status of cloud printing can be switched.

In a printer name 713, the printer name to be registered for cloud printing can be changed. In an endpoint 714, the endpoint of the cloud printing registration service 102 can be changed.

In a proxy setting 718, the setting for whether or not the cloud printing service communication destination is set to proxy exception can be changed by checking the on or off box. For example, before the cloud printing registration request 111 of FIG. 5 is transmitted, the edit button 605 on the screen 601 can be touched to set a proxy setting 618, set by default to off, to on. Also, even after registration, the URL for registration provided by the printing apparatus 101 can be accessed and the screen 701 can be displayed, allowing the settings to be changed in a similar manner from the screen 701.

By changing the proxy settings in this manner, a predetermined function, or in this example, the connection destination, i.e., endpoint, corresponding to the cloud printing service, can be registered as set to proxy exception. Accordingly, communication between a printing apparatus to be registered in the cloud printing service or a registered printing apparatus and an endpoint can be performed bypassing a proxy server.

FIG. 8 illustrates screens for operating the cloud printing registration service 102 for the client terminal 100 to complete cloud printing registration. Note that in a case where the operation panel 211 is used without a Web UI, the screen of FIG. 8 may be displayed on the operation panel 211.

The screen 801 is a screen that is displayed when the confirmation URL 130 is accessed via a Web browser or the like of the client terminal 100. The screen 801 is displayed in response to reception of the screen information 114 for cloud printing registration confirmation. A field 802 is an input field for the user to enter the user code 136. When the user enters the user code 136 in the field 802 and presses the OK button 803, the cloud printing registration approval request 115 is transmitted. In this response to this, when the user confirmation request is received, the screen transitions to the screen 811.

The screen 811 is a screen for entering the information of the user registering a printer. The user enters the cloud account 131 registered in advance into a user name input field 812 and the password into a password input field 813. Then, when a login button 814 is pressed, the login 140 is transmitted. In a case where login is successful and printer registration is successful, the cloud printing registration approval reply 116 is received and the screen transitions to the screen 821.

The screen 821 is a screen displayed after logging into the cloud printing service. In other words, the screen 821 is a screen displayed after the cloud printing registration approval reply 116 is received. The login name is displayed in a login name 823, and a tenant name the login user belongs to is displayed in a tenant name 824. Then, when a message indicating that cloud printing registration is complete is displayed and the OK button 822 is pressed, the screen transitions to the screen 831.

The screen 831 is screen where cloud services relating to the login user can be listed. A list 832 is a list displaying the cloud printers able to be used by the user. In this example, the screen 831 shows that two cloud printers, an MFP and a SFP, can be used. Also, the status of the cloud printers, such as idle or processing, can be referred to.

Processing to Change Proxy Settings

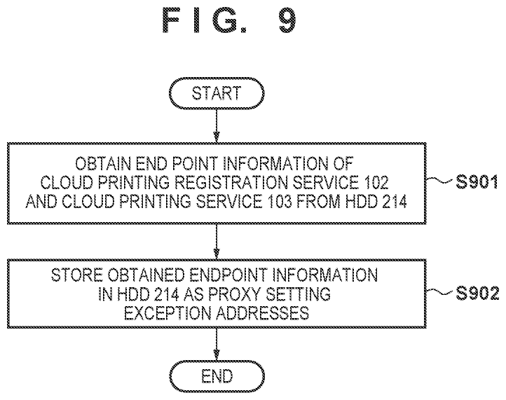

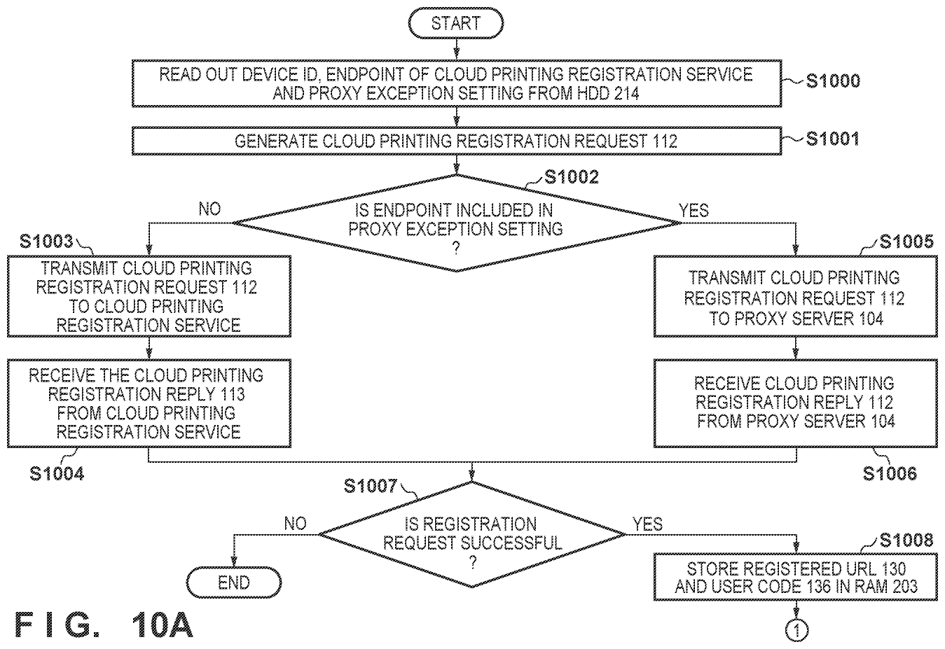

FIG. 9 is a flowchart of when the proxy settings of a cloud printer settings are changed for the printing apparatus 101 according to the first embodiment. The operations (steps) illustrated in the flowchart of FIG. 9 are implemented by the CPU 202 executing a control program stored in the ROM 204 or the HDD 214. Note that, also, to make clear the subject of the processing, the software modules executed by the CPU 202 described in reference to FIG. 3 may be used as the subject in the following descriptions. Hereinafter, in a similar manner, the flowcharts of FIGS. 10A, 10B, 11, and 13 described below are implemented by the CPU 202 executing a control program stored in the ROM 203 or the HDD 214.

Also, the flowchart of FIG. 9 is executed in a case where, on the cloud printing settings screen 711 illustrated in FIG. 7 for example, a user operation to change the proxy setting 718 from off to on is received.

In response to the operation to change the setting, in step S901, the storage unit 305 reads out the endpoint of the cloud printing registration service 102 and the endpoint of the cloud printing service 103 stored in the HDD 214. The operation to change the setting is performed from the user interface of the client terminal 100 or the operation panel 211. In step S902, the two pieces of endpoint information read out are stored (registered) in the HDD 214 as proxy setting exception addresses. Here, the change proxy setting value may also be changed from a value indicating off to a value indicating on and stored. Specifically, the storage unit 305 adds and registers an exception address to the list of exception addresses stored in the HDD 214. In the present embodiment, an exception address indicates an address (URL) that allows communications to bypass a proxy server. The list of registered exception addresses is referenced as appropriate in the flowcharts described below. Hereinafter, adding and registering an exception address to the list of exception addresses of the HDD 214 is also simply referred to as storing an exception address in the HDD 214.

Note that in a case where the proxy setting is changed from on to off, the value of the proxy setting can be stored in place of the post-change value and the endpoint information of the setting target stored as a proxy setting exception address can be removed from the list of exception addresses.

In this manner, the proxy setting can be changed from the client terminal 100 or the operation panel 211. The cloud printing service with the proxy exception setting set to on can then transmit a print job request for the cloud printing service and receive a print job from the cloud printing service bypassing the proxy server 104. Also, the cloud printing service with the proxy exception setting set to off can then transmit a print job request for the cloud printing service and receive a print job from the cloud printing service via the proxy server 104.

Note that in this example, the process includes the endpoint of the cloud printing service being registered as the proxy exception setting, because the proxy exception setting is selected after the endpoint of the cloud printing service is registered. However, the order may be reversed. In other words, in another example, the process may include determining whether a proxy exception setting has been selected when the endpoint of the cloud printing service is registered and, if it has been selected, registering the endpoint of the cloud printing service as the proxy exception setting.

Printer Registration Processing

FIGS. 10A and 10B is a flowchart illustrating the processing executed when cloud printing service printer registration is performed with the printing apparatus 101 according to the first embodiment. FIGS. 10A and 10B correspond to a processing process by the printing apparatus 101 from when the cloud printing registration request 112 of FIG. 5 is transmitted to when the cloud printing registration confirmation reply 118 is received.

In response to a user operation, in step S1000, the storage unit 305 reads out the device ID, the endpoint of the cloud printing registration service 102, and the proxy exception setting stored in the HDD 214. The user operation is performed with the operation panel 211 or the client terminal 100. However, this does not change anything with the setting processing of the processing of the printing apparatus 101, and thus the user interface is not referred to specifically in the description.

In step S1001, the cloud printing registration control unit 301 uses the read out device ID and generates the cloud printing registration request 112.

In step S1002, the cloud printing registration control unit 301 determines whether the endpoint of the cloud printing registration service 102 is included in the proxy exception setting.

In a case where the result of the determination is NO, in step S1003, the cloud printing registration control unit 301 directly transmits the cloud printing registration request 112 to the endpoint of the cloud printing registration service 102. Then, in step S1004, the cloud printing registration control unit 301 directly receives the cloud printing registration reply 113 from the endpoint of the cloud printing registration service 102. Note that in FIGS. 10A and 10B, “endpoint” is omitted to facilitate understanding. This may also hold true for other steps.

In a case where the result of the determination is YES, in step S1005, the proxy communication control unit 304 transmits the cloud printing registration request 112 addressed to the endpoint of the cloud printing registration service 102 to the proxy server 104. Then, in step S1006, the proxy communication control unit 304 receives the cloud printing registration reply 113 transmitted by the endpoint of the cloud printing registration service 102 from the proxy server 104.

In step S1007, the cloud printing registration control unit 301 analyzes the cloud printing registration request reply and determines whether or not the registration request was successful. In a case where the result of the determination is NO, the processing ends.

In a case where, in step S1007, the result of the determination is YES, in step S1008, the cloud printing registration control unit 301 stores the confirmation URL 130 and the user code 136 included in the cloud printing registration reply 113 in the RAM 203. Thereafter, a cloud printing registration approval request and reply process plays out between the client terminal 100 and the cloud printing registration service 102, and then printer registration is complete.

Following on from this, in the printing apparatus 101, the cloud printing registration confirmation process is executed. From step S1009 to step S1015 is processing that is repeated for executing registration confirmation until registration confirmation is completed.

In step S1010, the cloud printing registration control unit 301 determines whether the endpoint of the cloud printing registration service 102 is included in the proxy exception setting. In a case where the result of the determination is NO, in step S1011, the cloud printing registration control unit 301 directly transmits the cloud printing registration confirmation request 117 to the endpoint of the cloud printing registration service 102. Then, in step S1012, the cloud printing registration control unit 301 directly receives the cloud printing registration confirmation reply 118 from the endpoint of the cloud printing registration service 102.

On the other hand, in a case where the result of the determination in step S1010 is YES, in step S1013, the proxy communication control unit 304 transmits the cloud printing registration confirmation request 117 addressed to the endpoint of the cloud printing registration service 102 to the proxy server 104. Then, in step S1014, the proxy communication control unit 304 receives the cloud printing registration confirmation reply 118 transmitted by the endpoint of the cloud printing registration service 102 from the proxy server 104.

In step S1015, the cloud printing registration control unit 301 analyzes the cloud printing registration confirmation reply 118 and determines whether or not the registration confirmation was successful. In a case where it is not successful, the processing from step S1009 is repeated. In a case where it is successful, in step S1016, the cloud printing registration control unit 301 stores the cloud device ID 132 and the cloud printing service URL 137 included in the cloud printing registration confirmation reply 118 in the HDD 214.

In step S1017, the cloud printing registration control unit 301 determines whether or not the cloud printing proxy exception setting is ON. In a case where it is ON, in step S1017, the storage unit 305 stores the cloud printing service URL 137 in the HDD 214 as a proxy setting exception address.

Via the process described above, communications with the endpoint registered as a proxy exception setting are performed bypassing the proxy server 104.

Performing Cloud Printing

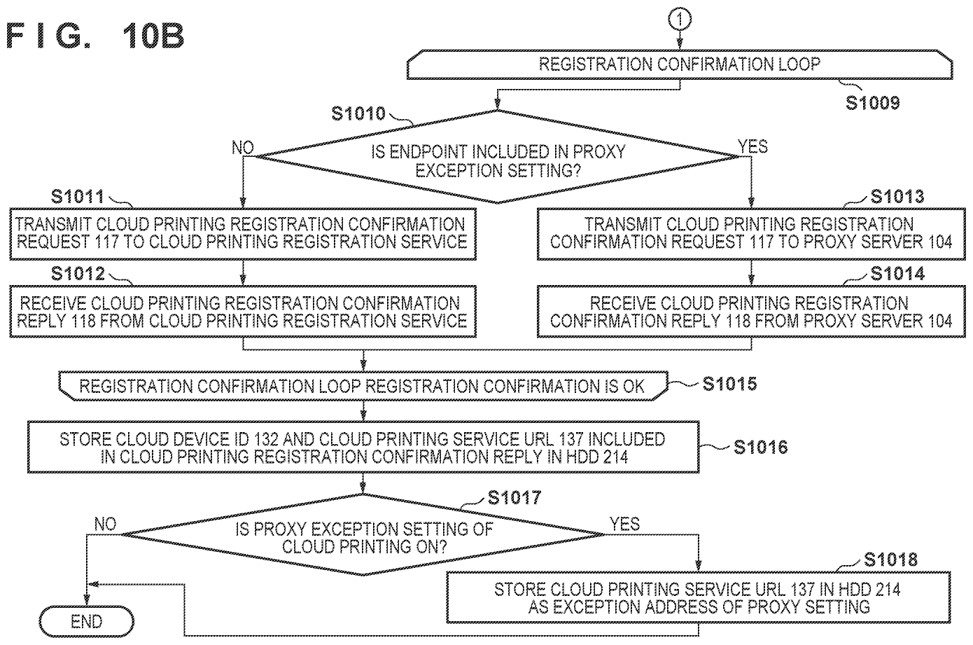

FIG. 11 is a flowchart illustrating the processing executed when printing with the cloud printing service is performed via the printing apparatus according to the first embodiment. This processing corresponds to processing executed by the printing apparatus 101 from when the print job request 120 of FIG. 5 is transmitted to when the print job reply 121 is received and printing is executed.

In step S1100, the storage unit 305 reads out the cloud device ID, the endpoint of the cloud printing service, and the proxy exception setting list stored in the HDD 214.

In step S1101, the cloud printing control unit 302 generates the print job request 120.

In step S1102, the cloud printing control unit 302 determines whether the endpoint of the cloud printing service is included in the proxy exception setting list. In a case where the result of the determination is NO, in step S1103, the cloud printing control unit 302 directly transmits the print job request 120 to the endpoint of the cloud printing service. Then, in step S1104, the cloud printing control unit 302 directly receives the print job reply 121 from the endpoint of the cloud printing service.

In a case where the result of the determination in step S1102 is YES, in step S1105, the proxy communication control unit 304 transmits the print job request 120 addressed to the endpoint of the cloud printing service to the proxy server. Then, in step S1106, the proxy communication control unit 304 receives the print job reply 121 transmitted by the endpoint of the cloud printing service from the proxy server.

In step S1107, the cloud printing control unit 302 extracts the print data 134 from the print job reply 121. In step S1108, the print processing unit 307 prints the received print data 134.

Via the process described above, communications with the endpoint registered as a proxy exception setting, in particular communications including a print job, can be performed bypassing the proxy server 104. Thus, the communication load on the proxy server 104 can be reduced, and delay and damage to communications can be prevented. Also, as described with reference to FIG. 7, the proxy exception setting can be set by operating a checkbox on a settings screen, making it very easy-to-use and user-friendly. Accordingly, a user without special knowledge relating to network settings and without knowledge relating to set an endpoint as the proxy exception setting target can perform operations to easily and without error set the settings.

### Second Embodiment

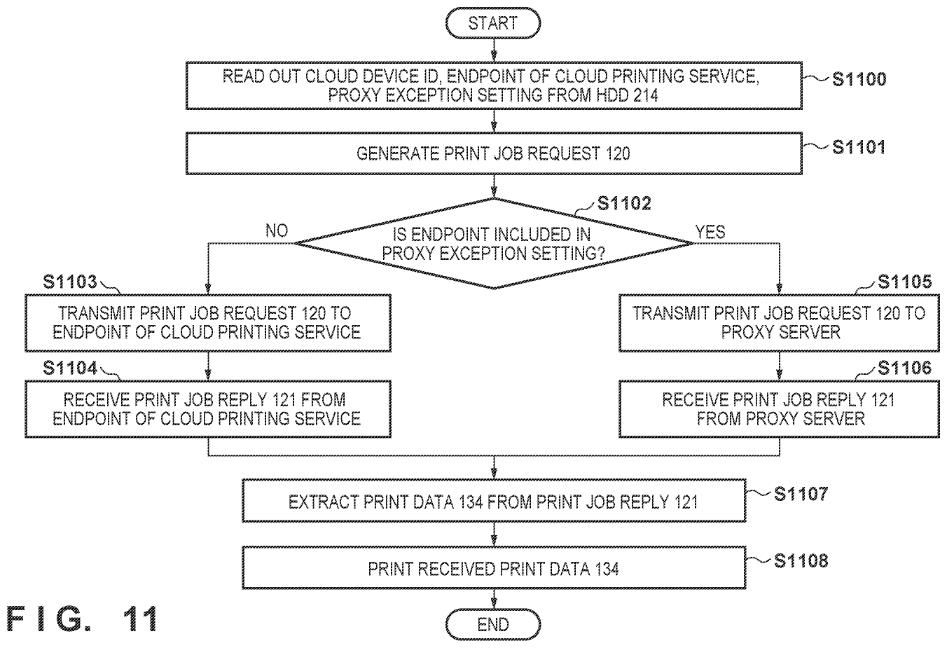

In the second embodiment, a setting is provided for controlling whether or not the proxy exception setting is to be performed per function or per application in the proxy setting of the printing apparatus 101. By enabling the proxy exception setting, the communication destination of the application can be automatically added as a proxy exception. FIG. 12 is a diagram of a UI where proxy setting of the printing apparatus 101 is performed on the printing apparatus 101 according to the second embodiment.

When the user presses a setting/registration button 1201 on a home screen 1200, the operation control unit 300 displays a setting/registration screen 1210. On the setting/registration screen 1210, various settings of the printing apparatus 101 can be set. In the present embodiment, IPv4 setting, IPv6 setting, RAW print setting, LPD print setting, HTTP proxy setting, and the like can be set. The user may press a HTTP proxy setting button 1211 on the setting/registration screen 1210.

When the HTTP proxy setting button 1211 is pressed, the operation control unit 300 displays a HTTP proxy setting screen 1220. The operation control unit 300 displays, on the HTTP proxy setting screen 1220, a selection button 1221 for whether or not to use a proxy, a proxy server address 1222, a proxy server port number 1223, and a selection button 1224 for whether or not to use proxy authentication. Furthermore, the operation control unit 300 displays, on the HTTP proxy setting screen 1220, a button 1225 for setting the proxy exception setting.

When the proxy exception setting button 1225 is pressed, the operation control unit 300 displays a HTTP proxy exception setting screen 1230. In a proxy exception address 1231, the address for proxy exception can be set. A proxy communication control unit 604 of the printing apparatus 101 performs communications according to the HTTP proxy setting set here.

In a proxy exception function selection button 1232, a function for proxy exception setting can be set. Here, proxy exception setting can be performed for functions including cloud printing and uniFLOW online. When the proxy exception setting is ON, all communications of the function is performed bypassing the proxy. In other words, in a case where an endpoint of a target function is registered as a proxy exception address, communications are performed in a similar manner.

By changing the proxy settings for a function selected from a list in this manner, the selected function, for example, the connection destination, i.e., endpoint, corresponding to the cloud printing service, can be registered as set to proxy exception. Accordingly, communication between a printing apparatus to be registered in the cloud printing service or a registered printing apparatus and an endpoint can be performed bypassing a proxy server.

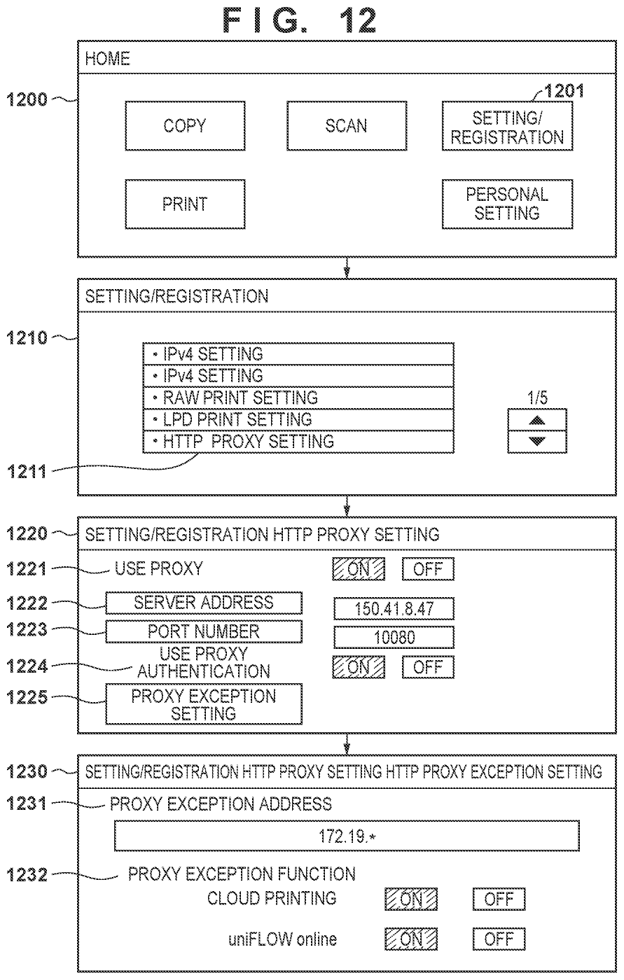

FIG. 13 is a flowchart for when the proxy exception function button 1232 is used to change the cloud printing from OFF to ON at the proxy exception setting screen 1230 of the printing apparatus according to the second embodiment. This processing is executed by the CPU 202. In step S1301, the storage unit 305 reads out the endpoint of the cloud printing service 103 and the endpoint of the cloud printing registration service 102 stored in the HDD 214. In step S1302, the two pieces of endpoint information read out are stored in the HDD 214 as proxy setting exception addresses by the storage unit 305. In this manner, the proxy exception setting can be easily set.

In FIG. 13, as in FIG. 9, in a case where the cloud printing service is registered with the proxy exception setting set to ON, the proxy exception setting may be applied to the registered cloud printing service.

The flowchart illustrating the processing executed when cloud printing service printer registration is performed with the printing apparatus 101 according to the second embodiment is the same as the flowchart described with reference to FIGS. 10A and 10B and thus description thereof is omitted. Also, the flowchart illustrating the processing when performing cloud printing service printing via the printing apparatus 101 according to the second embodiment is the same as the flowchart described with reference to FIG. 11 and thus description thereof is omitted.

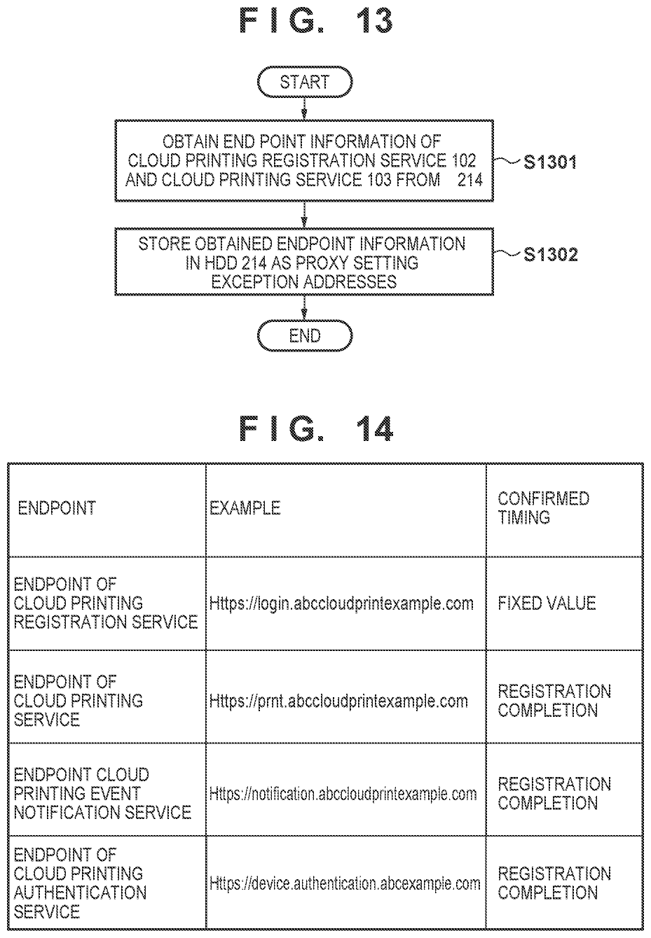

FIG. 14 is a list of endpoint information used by the printing apparatus 101 according to the first embodiment and the second embodiment.

The endpoint of the cloud printing registration service is the endpoint of the cloud printing registration service 102 described with reference to FIG. 5. This is a fixed URL.

The endpoint of the cloud printing service is the endpoint of the cloud printing service 103 described with reference to FIG. 5. This is a URL obtained from the cloud printing registration service 102 upon cloud printing registration.

The endpoint of the cloud printing event notification service is an endpoint used for the printing apparatus 101 to obtain an event, such as a job reception or job cancellation. This is a URL obtained from the cloud printing registration service 102 upon cloud printing registration.

The endpoint of the cloud printing authentication service is an endpoint used for the printing apparatus 101 to obtain authentication information (Oauth 2.0 token information) for accessing various cloud printing services. This is a URL obtained from the cloud printing registration service 102 upon cloud printing registration.

Note that the URL confirmed upon registration completion may include a character string generated on the basis of a random number or the like. In the present embodiment, in addition to the endpoints of the cloud printing service 102 and the cloud printing registration service 103, the endpoints of the cloud printing event notification service and the cloud printing authentication service may be collectively added to the proxy exception setting. In this manner, because the endpoints of the cloud printing services can be collectively registered as proxy exception settings, the user-friendliness can be further increased.

As described above, according to the first and second embodiment, communications with the endpoint registered as a proxy exception setting, in particular communications including a print job, can be performed bypassing the proxy server 104. Thus, the communication congestion at the proxy server 104 can be reduced, and delay and damage to communications caused by such congestion can be prevented. Also, the proxy exception setting is configured as a selection operation on the registration screen for cloud printing service or a network settings screen, making it extremely easy-to-use. Accordingly, a user without special knowledge relating to network settings and without knowledge relating to set an endpoint as the proxy exception setting target can perform operations to easily and without error set the settings.

### Modified Examples

In a case of a multi-functional device including a scanner, such as the printing apparatus 101, a cloud scanner may also be registered with the cloud platform providing the cloud printing service. A cloud scanning service according to the present embodiment is a service that transmits scan data obtained by reading a document with a scanner to a cloud storage provided by the cloud platform. In a case where the printing apparatus 101 is registered with the cloud platform as a cloud scanner, a similar problem occurs as the problem described above when the printing apparatus 101 is registered with the cloud printing service. Taking this problem into account, in a case where the printing apparatus 101 is registered as a cloud scanner with a scanning service, an endpoint (URL) necessary for communication with the cloud scanning service may also be collectively registered in the proxy exception setting. The endpoint to be registered for registering a scanner in the present modified example is expected to be an endpoint for accessing a cloud storage for accessing a cloud scanning service of a cloud platform. This can also be applied to the second embodiment. In this case, an object may be provided on the screen of FIG. 12 for whether or not to set the endpoint (URL) used in communications with the cloud scanning service as an exception address. A description of the processing executed in a case where there is an operation to set it as an exception address is omitted, because the processing is similar to that of the cloud printing service described with reference to FIGS. 12 and 13. Note that a function for communicating with the cloud scanning service provided by an external network is referred to as a cloud scanning function.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-128508, filed Jul. 29, 2020, which is hereby incorporated by reference herein in its entirety.

What is claimed is:

1. An image processing apparatus that communicates with an external apparatus on an external network via a proxy server, comprising:
at least one memory that stores a set of instructions; and
at least one processor that executes the instructions, the instructions, when executed, causing the image processing apparatus to perform operations comprising:
in a case where a setting for a predetermined function that communicates with the external network for allowing communication to bypass the proxy server is set to on, registering two or more connection destinations used by the predetermined function as exception addresses that allow communication to bypass the proxy server, and, in a case where communication is performed with an external connection destination, executing control such that communication is performed with the connection destination via the proxy server or bypassing the proxy server on the basis of whether or not the connection destination is registered in the exception addresses.

2. The image processing apparatus according to claim 1, further comprising:
a printing unit;
wherein the predetermined function is a cloud printing function that communicates with a cloud printing service.

3. The image processing apparatus according to claim 2, wherein
in a case where an operation is received to register the image processing apparatus with the cloud printing service and a setting for the cloud printing function for allowing communication to bypass the proxy server is set to on, the plurality of connection destinations used in communications with the cloud printing service for registration are registered as the exception addresses.

4. The image processing apparatus according to claim 2, wherein the operations further comprise:
executing control such that a settings screen for setting for the cloud printing function whether or not to allow communication to bypass the proxy server is displayed on a display device.

5. The image processing apparatus according to claim 4, wherein
the settings screen is a settings screen for the cloud printing service, and the settings screen includes at least a first object for setting for the cloud printing function whether or not to allow communication to bypass the proxy server and a second object for setting a printer name to be registered with the cloud printing service.

6. The image processing apparatus according to claim 4, wherein
the settings screen is a settings screen for setting settings for a proxy server, and the settings screen includes at least a first object for setting for the cloud printing function whether or not to allow communication to bypass the proxy server and a second object for entering an exception address on the basis of a user operation.

7. The image processing apparatus according to claim 2, wherein
the plurality of connection destinations corresponding to the cloud printing service includes at least a connection destination used in registering the image processing apparatus with the cloud printing service and a connection destination used in obtaining print data.

8. The image processing apparatus according to claim 1, further comprising:
a scanner that reads a document and obtains an image;
wherein the predetermined function is a cloud scanning function that communicates with a cloud scanning service.

9. A non-transitory storage medium storing a program for causing a computer to execute a method for controlling an image processing apparatus that communicates with an external apparatus on an external network via a proxy server, the method comprising:
in a case where a setting for a predetermined function that communicates with the external network for allowing communication to bypass the proxy server is set to on, registering two or more connection destinations used by the predetermined function as exception addresses that allow communication to bypass the proxy server, and
in a case where communication is performed with an external connection destination, executing control such that communication is performed with the connection destination via the proxy server or bypassing the proxy server on the basis of whether or not the connection destination is registered in the exception addresses.

10. A method of controlling an image processing apparatus that communicates with an external apparatus on an external network via a proxy server, the method comprising:
in a case where a setting for a predetermined function that communicates with the external network for allowing communication to bypass the proxy server is set to on, registering two or more connection destinations used by the predetermined function as exception addresses that allow communication to bypass the proxy server; and
in a case where communication is performed with an external connection destination, executing control such that communication is performed with the connection destination via the proxy server or bypassing the proxy server on the basis of whether or not the connection destination is registered in the exception addresses.
